(19) United States
(12) Patent Application Publication
(10) Pub. No.: US 2007/0058337 A1
(43) Pub. Date: Mar. 15, 2007

(54) Manually controllable fan assembly

(76) Inventor: Steve Cheng, Tao Yuan Shien (TW)

Correspondence Address: RABIN & BERDO, P.C.;Suite 500, 1101 14 Street, N.W., Washington, DC, 20005, US

(21) Appl. No.: 11/331,259

(22) Filed: Jan. 13, 2006

(30) Foreign Application Priority Data
Sep. 15, 2005 (TW) 94131929

(51) Int. Cl. G06F 1/20

(52) U.S. Cl. 361/687; 361/688

(57) ABSTRACT

A fan assembly able to be configured in a computer is provided. The fan assembly includes a controller and a fan. The controller is electrically connected to a keyboard of the computer for receiving and processing a signal input from the keyboard of the computer, wherein the controller is independent from a CPU of the computer. The fan is electrically connected to the controller for receiving the signal processed by the controller so as to control the fan.

### RELATED APPLICATIONS

The present application is based on, and claims priority from, Taiwan Application Ser. No. 94131929, filed Sep. 15, 2005, the disclosure of which is hereby incorporated by reference herein in its entirety.

### BACKGROUND

1. Field of Invention

The present invention relates to a fan assembly. More particularly, the present invention relates to a manually controllable fan assembly.

2. Description of Related Art

Manufacturing technology of electrical products has improved along with advances in product technology in recent years. Almost all electrical products need to be lightweight, thin, small and convenient to use in order to meet the desires of modern users. For example, notebook computers are very popular because they are easy to carry but still very capable of processing digital information.

A traditional notebook computer has a fan configured inside for preventing the temperature of a central processing unit (CPU) or an inner space of the notebook from increasing too much, which could cause the notebook to crash. A traditional fan is controlled by hardware or software of the notebook computer to start, stop, accelerate or decelerate the fan. Specifically, the fan is started when the temperature of the CPU of the notebook computer is higher than a predetermined temperature. The higher the temperature is of the CPU, the faster the rotation rate is of the fan. Thus, the fan is able to exhaust the heat generated from the CPU or the inner space out from the notebook. When the temperature of the CPU or the inner space of the notebook computer is lower than another predetermined temperature, the fan is stopped automatically for saving energy such that the working time of a notebook computer battery is lengthened. Moreover, noise level produced by the fan is reduced by stopping the fan.

However, each user of the notebook computer has a different noise tolerance and has different expectations for what temperature should start the fan, and what battery working time should be available. That is, the traditional notebook computer does not enable the user to start the fan or accelerate the rotation rate of the fan manually to drop the temperature no matter how much noise is produced or how much energy is lost; nor can the user stop the fan or decelerate the rotation rate of the fan manually to reduce the noise or lengthen the working time of the battery.

### SUMMARY

It is therefore an aspect of the present invention to provide a manually controllable fan assembly configured in a computer, wherein the fan assembly is able to be started manually.

It is another aspect of the present invention to provide a manually controllable fan assembly configured in a computer, wherein the rotation rate of the fan assembly is able to be accelerated manually.

It is still another aspect of the present invention to provide a manually controllable fan assembly configured in a computer, wherein the rotation rate of the fan assembly is able to be decelerated manually.

It is therefore yet another aspect of the present invention to provide a manually controllable fan assembly configured in a computer, wherein the fan assembly is able to be stopped manually.

In accordance with the foregoing and other aspects of the present invention, a manually controllable fan assembly able to be configured in a computer is provided. The fan assembly includes a controller and a fan. The controller is electrically connected to a keyboard of the computer for receiving and processing a signal input from the keyboard of the computer, wherein the controller is independent from a CPU of the computer. The fan is electrically connected to the controller for receiving the signal processed by the controller such that the fan can be controlled.

According to one preferred embodiment of the invention, the signal may be a start or stop signal for starting or stopping the fan. Moreover, the signal may also be an acceleration or a deceleration signal for accelerating or decelerating the rotation rate of the fan.

Furthermore, the fan assembly according to one embodiment of the invention includes a thermometer used for measuring the temperature of the central processing unit of the computer. The thermometer is electrically connected to the controller such that the controller controls the rotation rate of the fan according to the measured temperature of the central processing unit of the computer.

The manually controllable fan assembly is able to be configured in any type of computer, preferably a notebook computer. Users can control the starting, stopping and rotation rate of the fan easily and conveniently by manually inputting a signal from the keyboard of the computer.

It is to be understood that both the foregoing general description and the following detailed description are by examples and are intended to provide further explanation of the invention as claimed.

### BRIEF DESCRIPTION OF THE DRAWINGS

The accompanying drawing is included to provide a further understanding of the invention and is incorporated in and constitutes a part of this specification. The drawing illustrates an embodiment of the invention and, together with the description, serves to explain the principles of the invention, wherein:

FIG. 1 is a block diagram of a manually controllable fan assembly according to one preferred embodiment of the invention.

### DESCRIPTION OF THE PREFERRED EMBODIMENT

Reference will now be made in detail to the present preferred embodiment of the invention, an example of which is illustrated in the accompanying drawing. Wherever possible, the same reference numbers are used in the drawing and the description to refer to the same or like parts.

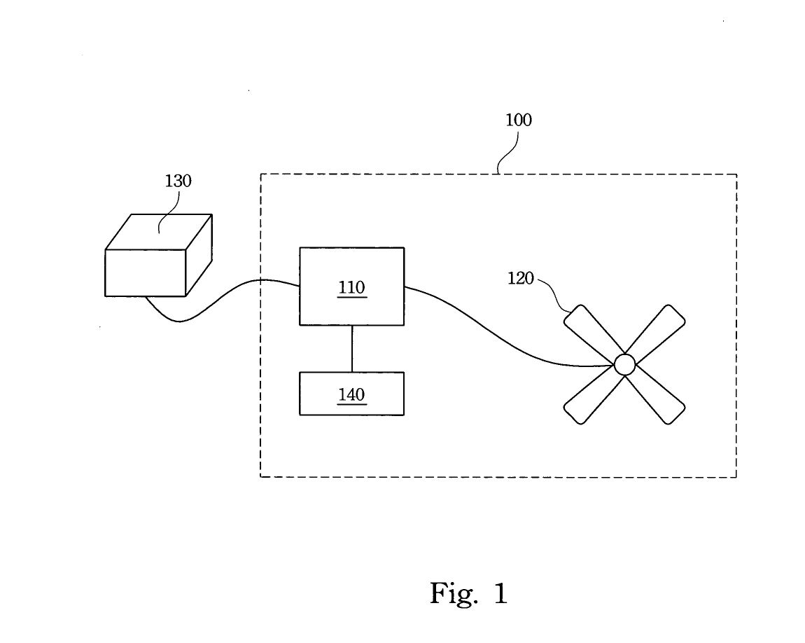

Reference is made to FIG. 1, which is a block diagram of a manually controllable fan assembly according to one preferred embodiment of the invention. A fan assembly 100 able to be configured in a computer is provided in FIG. 1. The fan assembly 100 includes a controller 110 and a fan 120. The controller 110 is electrically connected to a keyboard 130 of the computer for receiving and processing a signal input from the keyboard 130 of the computer, wherein the controller 110 is independent from a CPU of the computer. The fan 120 is electrically connected to the controller 110 for receiving the signal processed by the controller 110 and is controlled by the signal.

According to one preferred embodiment of the invention, the signal may be a start or stop signal for starting or stopping the fan 120. Moreover, the signal may also be an acceleration or a deceleration signal for accelerating or decelerating the rotation rate of the fan 120.

In addition, the keyboard 130 may include an on/off key used for inputting the start or stop signal for starting or stopping the fan 120. The keyboard 130 may also include an acceleration or a deceleration key used for inputting the acceleration or deceleration signal for accelerating or decelerating the rotation rate of the fan 120. Moreover, the keyboard 130 may include hot keys; that is, users may input different key combinations to transmit different signals. Although the keyboard 130 is the keyboard of the computer, the keyboard 130 may also be any other input device such as a button or a wheel.

Furthermore, the fan assembly 100 according to this embodiment of the invention includes a thermometer 140 used for measuring the temperature of the central processing unit of the computer. The thermometer 140 is electrically connected to the controller 110 such that the controller 110 controls the rotation rate of the fan 120 according to the measured temperature of the central processing unit of the computer. The thermometer 140 may be any type of thermometer, for example, a bimetal thermometer, a thermocouple, a resistance temperature detector, a thermistor, an integrated circuit temperature sensor, or a radiation thermometer.

In conclusion, the preferred embodiment of the invention has advantages of:

(1) users can control the fan manually because the fan is able to be controlled by the signal originally input from the keyboard;

(2) users can start or stop the fan manually because the fan is able to be started or stopped by the signal originally input from the keyboard; and

(3) users can accelerate or decelerate the rotation rate of the fan manually because the rotation rate of the fan is able to be accelerated or decelerated by the signal originally input from the keyboard.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer comprising:
an input device used for inputting a signal;
a controller electrically connected to the input device for receiving and processing the signal, wherein the controller is independent from a central processing unit of the computer; and
a fan electrically connected to the controller for receiving the signal processed by the controller, whereby the signal processed by the controller is used for controlling the fan.

2. The computer of claim 1, wherein the signal comprises a start signal for starting the fan.

3. The computer of claim 1, wherein the signal comprises a stop signal for stopping the fan.

4. The computer of claim 1, wherein the signal comprises an acceleration signal for accelerating the rotation rate of the fan.

5. The computer of claim 1, wherein the signal comprises a deceleration signal for decelerating the rotation rate of the fan.

6. The computer of claim 1, wherein the input device comprises a key electrically connected to the controller.

7. The computer of claim 1, wherein the input device comprises an on/off key electrically connected to the controller.

8. The computer of claim 1, wherein the input device comprises an acceleration key electrically connected to the controller.

9. The computer of claim 1, wherein the input device comprises a deceleration key electrically connected to the controller.

10. The computer of claim 1, further comprising a thermometer used for measuring the temperature of the central processing unit of the computer, and the thermometer is electrically connected to the controller such that the controller controls the rotation rate of the fan according to the temperature of the central processing unit of the computer.

11. A method for controlling a fan of a computer, comprising the steps of:
inputting a signal;
transmitting the signal to a controller;
processing the signal by the controller;
transmitting the signal processed by the controller to the fan; and
controlling the fan by the signal processed by the controller.

12. The method of claim 11, wherein the signal comprises a start signal for starting the fan.

13. The method of claim 11, wherein the signal comprises a stop signal for stopping the fan.

14. The method of claim 11, wherein the signal comprises an acceleration signal for accelerating the rotation rate of the fan.

15. The method of claim 11, wherein the signal comprises a deceleration signal for decelerating the rotation rate of the fan.

16. The method of claim 11, wherein the step of inputting the signal is done by pushing a key of the computer.

17. A fan assembly configured in a computer, the fan assembly comprising:
a controller electrically connected to a keyboard of the computer for receiving and processing a signal input from the keyboard, wherein the controller is independent from a central processing unit of the computer; and
a fan electrically connected to the controller for receiving the signal processed by the controller, whereby the signal processed by the controller is used for controlling the fan.

18. The fan assembly of claim 17, wherein the signal is selected from the group consisting of a start signal, a stop signal, an acceleration signal and a deceleration signal.

19. The fan assembly of claim 17, wherein the keyboard comprises an on/off key, an acceleration key and a deceleration key.

20. The fan assembly of claim 17, further comprising a thermometer used for measuring the temperature of the central processing unit of the computer, and the thermometer is electrically connected to the controller such that the controller controls the rotation rate of the fan according to the temperature of the central processing unit of the computer.
